(19) United States
(12) Patent Application Publication
(10) Pub. No.: US 2004/0000061 A1
(43) Pub. Date: Jan. 1, 2004

(54) Apparatus for installing a frame and related appurtenances

(76) Inventor: Robert L. Tuthill, Carbon Hill, OH (US)

Correspondence Address: Gallagher & Dawsey Co., L.P.A., Suite 226, 1487 W. Fifth Ave., Columbus, OH, 43212, US

(21) Appl. No.: 10/185,183

(22) Filed: Jun. 28, 2002

(51) Int. Cl. E04B 1/00; E06B 3/00

(52) U.S. Cl. 33/194; 52/105; 52/749.1

(57) ABSTRACT

An apparatus for installing a frame and related appurtenances incorporating, among other elements, four corner members slidably and releasably joined with height and width adjusters. The apparatus may be used in the plurality of assembly activities that require the assembly of a frame, including, but not limited to, cabinet making, furniture making, window framing, trimming, and installation, and door framing, trimming, and installation. Each corner member includes two sections that are substantially orthogonal to one another and may be foldable so that they are substantially parallel when in the folded position. Additionally, each member may be formed with a trim piece mounting ledge to provide a surface to abut a frame trim section to assure a uniform reveal, and stop, hinge, and strike templates. The apparatus frame members may be formed with a unique thickness, or may include trim setback members, to accommodate varying jamb material thickness and the desired reveal.

### TECHNICAL FIELD

The invention relates to the field of portable carpentry tools and generally a jig for the installation of frames, doors frames, door jambs, window frames, and related appurtenances.

### BACKGROUND OF THE INVENTION

Hanging and trimming doors, door jambs, windows, and similar openings is a difficult and time-consuming procedure that traditionally has been regarded as one of the highest skills in the carpentry trade. Tools that will allow such highly skilled trim carpenters to work more efficiently will decrease building costs. Additionally, there has been a need for many years for carpentry tools that allow relatively less-skilled laborers to perform activities previously limited to those with significant carpentry experience.

A door frame generally consists of a head jamb that spans between two side jambs, a hinge jamb and a strike jamb, at the top of a doorway. The jambs are secured to studs that form a rough opening for the doorway. The skilled process of installing the door frame is essential to a good door installation. For instance, the hinge jamb and the strike jamb must be substantially parallel and plumb or the door will not swing properly and the space between the door edge and the edges of the jambs will not be uniform. Additionally, each side jamb must be substantially orthogonal to the head jamb, which must be substantially level.

Additionally, a door stop must be installed. Further appurtenances including a strike plate and hinges must also be properly located to provide a mechanical system for fastening the door in a closed position and for allowing the door to swing open and shut. Decorative trim is traditionally installed around the top and sides of a door, door jamb, casement windows and other jamb type openings. This trim is set back from the edge of the jambs by a uniform distance, called a reveal, for improved cosmetics and to prevent the trim from causing the door to bind when opening or shutting.

The process of establishing the required relationships between the components of the door frame to ensure a good door installation is often complicated by many factors. For example, the conventional framing lumber used to frame a rough door opening is often twisted or warped. Additionally, the tolerances of rough framing generally do not provide the degree of level or plumb required for proper operation of a door. Further, the door jambs may be warped, non-uniform, or cambered as shipped from the production facility or as constructed at the job site. These problems must be accounted for during the installation of the door frame or the door may not open and close properly. Additionally, the door may strike the floor, the head jamb, or the doorjamb. These problems are exacerbated in restoration or renovation work, where a myriad of problems may be present, such as fitting new doors to existing jambs, the presence of doors or jambs of irregularly sized or shaped openings by today's construction standards, or by warping or sagging of an old building structure.

Traditionally, skilled carpenters have attempted to overcome these problems in a number of ways. However, none of these methods achieve the results of the present invention. Most commonly, skilled carpenters use a number of tapered shims inserted between the jambs and the studs to obtain the appropriate relationships between the jambs. This process typically requires a skilled carpenter to insert shims at three or more locations on each jamb. The shims are then adjusted as the carpenter holds a three to six foot long level against the door frame. The need to hold, level or plumb, and secure shims typically requires a helper. Installation of a door frame in this manner may consume forty-five minutes of a skilled carpenter's time. Unskilled laborers often attempt this process unsuccessfully, resulting in poorly installed doors that often must be re-installed by skilled carpenters.

Various devices have attempted to improve this process. For example, U.S. Pat. No. 6,282,852 granted to Walcker on Sep. 4, 2001, comprises a template for installing a door frame. However, it is not adjustable for varying heights to accommodate non-standard doors, windows, or other openings. It is useful for plumbing door jambs, but does not provide for a means of quickly and accurately installing a door stop or trim, and in fact, a stop or trim could not be installed with the Walcker '852 device in place in the door frame, as the device when in use covers the areas where a stop or trim would need to be installed. Similarly, U.S. Pat. No. 6,237,233, granted to Cloutier et al., on May 29, 2001 is limiting in that it requires that a door stop and trim be installed in a separate operation after the squaring of the door frame. Additionally, both the Walcker '852 device and the Cloutier et al. '233 device would be relatively inconvenient to transport.

What continues to be needed but is missing from the field of carpentry tools is a lightweight easy to use device that is conveniently transported, adjustable for a variety of door and opening configurations, and constructed to retain the tolerances required for proper door installation. Additionally, the device should provide a repeatable process that can be perfected by unskilled laborers and repeated on door frames of varying sizes. Further, the device must be easy to transport and constructed to withstand damage from dropping and general abuse associated with the use of the device. Lastly, the device should minimize the steps necessary for the installation of a door, window, or other opening by allowing for stops and trim installation coincident with the plumbing and leveling of the door frame. While some of the prior art devices attempted to improve the state of the art of door frame installation tools, none has achieved the cost optimized capability that is easy to fabricate and convenient to use of the present invention. With these capabilities taken into consideration, the instant invention addresses many of the shortcomings of the prior art and offers significant benefits heretofore unavailable.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations.

In one of the many preferable configurations, the apparatus for installing a frame and related appurtenances incorporates, among other elements, four corner members slidably and releasably joined together with height and width adjusters. The four corner members include a head-hinge frame member, a head-strike frame member, a base-hinge frame member, and a basestrike frame member. Each member is formed with a trim piece mounting ledge.

Each corner member includes two sections that are orthogonal to one another while in use. The two sections may be foldable so that they are substantially parallel to each other when in the folded position. While in use, at least one hinged stabilization member may be used to join the two sections ensuring their orthogonal relationship and providing additional stability and rigidity to the apparatus. The two sections of the head-hinge frame member include an upper hinge frame section and a hinge side head frame section. Similarly, the head-strike frame member includes an upper strike frame section and a strike side head frame section. Additionally, the base-hinge frame member includes a lower hinge frame section and a hinge side base frame section. Lastly, the base-strike frame member includes a lower strike frame section and a strike side base frame section.

The head-hinge frame member and the head-strike frame member are adjustably and releasably joined together with a horizontal head width adjuster having a hinge end and a strike end. The hinge end slidably and releasably mates with the hinge side head frame section of the head-hinge frame member. The strike end slidably and releasably mates with the strike side head frame section of the head-strike frame member.

The base-hinge frame member and the base-strike frame member are adjustably and releasably joined together with a horizontal base width adjuster having a hinge end and a strike end. The hinge end slidably and releasably mates with the hinge side base frame section of the base-hinge frame member. The strike end slidably and releasably mates with the strike side base frame section of the base-hinge frame member.

The head-hinge frame member and the base-hinge frame member are adjustably and releasably joined together with a vertical hinge height adjuster having a lower end and an upper end. The lower end slidably and releasably mates with the hinge side base frame section of the base-hinge frame member. The upper end slidably and releasably mates with the upper hinge frame section of the head-hinge frame member.

The head-strike frame member and the base-strike frame member are adjustably and releasably joined together with a vertical strike height adjuster having a lower end and an upper end. The lower end slidably and releasably mates with the strike side base frame section of the base-strike frame member. The upper end slidably and releasably mates with the upper strike frame section of the head-strike frame member.

As noted above, each of the apparatus corner frame members is formed with a trim piece mounting ledge. The trim piece mounting ledge provides a surface against which a user can abut a frame trim section to assure a uniform reveal, the amount of jamb material exposed to view once the frame trim section is installed. The apparatus frame members may be formed with a unique thickness, or may include trim setback members, to accommodate varying jamb material thickness and the desired reveal.

Additionally, the apparatus may include a number of trim setback extension members to vary the reveal. For instance, one embodiment set-up for a standard one-quarter inch reveal may be modified to provide any number of alternative reveals through the use of trim setback extension members. Such trim setback extension members may be releasably and slidably attached to the apparatus frame members. Further, they may be hingedly attached to the apparatus frame members to swing into position when desired and retract when the apparatus' standard reveal is desired.

In additional embodiments, any of the adjusters described above may include measurement indicia. Such indicia may aide in assuring orthogonal nature of all corners of the apparatus. Additionally the apparatus may include a plurality of level and plumb indicating devices attached to the apparatus. The level and plumb indicating devices may be of the traditional bubble and liquid type or more advanced electronic indicators.

Generally the corner members' depth will be such to locate the desired position of one of the many potential appurtenances attached to the jambs during the framing process. For example, when the apparatus is utilized in the framing of doors the corner members' depth may be approximately equal to standard depth of a door. This would allow the user to abut the pieces of a door stop against the apparatus corner members thereby ensuring the correct location of the stop on the jamb. Further, a plurality of stop locator extension devices may be releasably and slidably secured to the apparatus frame members. Such stop locator extension devices may be convenient when using an apparatus of a specific depth to locate the door stop of a door having a depth greater than that of the apparatus. Additionally, the stop locator extension devices may be hingedly attached to the apparatus frame members to swing into position when desired and retract when unnecessary.

Additional embodiments may include an intermediate adjustable brace that may be adjustably and releasably attached to the apparatus. The intermediate adjustable brace may add strength and rigidity to the apparatus while also preventing bowing of the apparatus. Such a intermediate brace may be particularly useful in framing large openings such as those required for sliding glass doors. Further, the intermediate brace may include measurement indicia. Such indicia may aide in assuring orthogonal nature of all corners of the apparatus.

Further, an additional embodiment directed toward the installation of door frames may include at least one hinge template adjustably attached to the apparatus. The hinge template may be designed for use with a router, hand tools, or simply to outline a hinge size and location. The hinge template may be adjustably attached to the apparatus so that the entire template may be moved on the apparatus. Additionally, the hinge template itself may be adjustable to accommodate the mortising of standard 3″, 3-½″ and 4″ hinges as well as any custom hinge size and any door thickness. An additional variation includes a door strike template adjustably attached to the apparatus. The door strike template may include both a template for the strike plate and a template for the lock bolt.

Any of the preceding embodiments may include a plurality of gripping devices attached to the apparatus for ease in handling.

Generally, by way of example and not limitation, when the apparatus is utilized for installing a new door frame in new construction the apparatus will be secured to the door jambs on the floor or a workbench ensuring the substantially orthogonal nature of the jambs. Once secured the apparatus and the frame are lifted and placed into the rough framed opening. The level and plumb indicating devices are then utilized to obtain the desired orientation of the assembly. Shims are then installed between the jambs and the studs and the jambs are secured to the studs. Now with the frame both level and plumb, and the jambs parallel or orthogonal to each other as required, the trim pieces and door stops may be easily installed by aligning them against the trim piece mounting ledge, or trim setback extension member, and the frame members, or stop locator extensions, respectively. The hinge templates and door strike template may then be used to mortise hinge, strike, and bolt recesses into the jambs.

These variations, modifications, alternatives, and alterations of the various preferred embodiments, arrangements, and configurations may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is a detailed elevated right side perspective view, in reduced scale, of a typical door frame and associated appurtenances.

FIG. 2 is a detailed elevated left side perspective view, in reduced scale, of the door frame and associated appurtenances of FIG. 1.

FIG. 3 is a detailed elevated right side perspective view, in reduced scale of the door frame and associated appurtenances of FIG. 1 including various trim components.

FIG. 4 is a detailed elevated perspective view, in reduced scale, of the apparatus for installing a frame and related appurtenances.

FIG. 5 is a detailed elevated perspective view, in reduced scale, of a variation of the apparatus for installing a frame and related appurtenances shown in FIG. 4.

FIG. 6 is a detailed elevated perspective view, in reduced scale, of a variation of the apparatus for installing a frame and related appurtenances shown in FIG. 4 including the door frame components and appurtenances shown in FIG. 3.

FIG. 7 is a detailed sectional view taken along section line 1-1 shown in FIG. 6.

Also, in the various figures and drawings, the following reference symbols and letters are used to identify the various elements described herein below in connection with the several figures and illustrations: DS, H, HGJ, HGT, HJ, HT, SJ, SP, and ST.

### DESCRIPTION OF THE INVENTION

The apparatus for installing a frame and related appurtenances of the instant invention enables a significant advance in the state of the art of carpentry tools. The preferred embodiments of the apparatus for installing a frame and related appurtenances accomplish this by new and novel arrangements of elements that are configured in unique and novel ways and which demonstrate previously unavailable but preferred and desirable capabilities.

The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

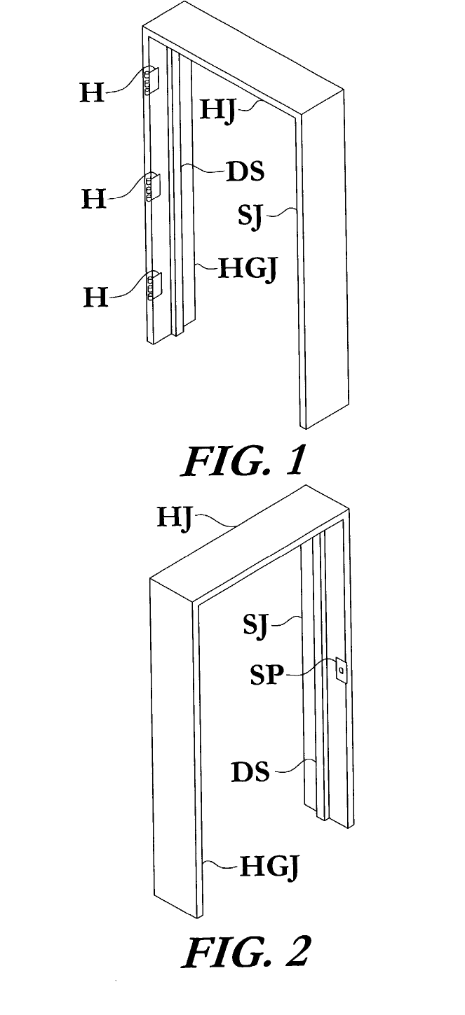

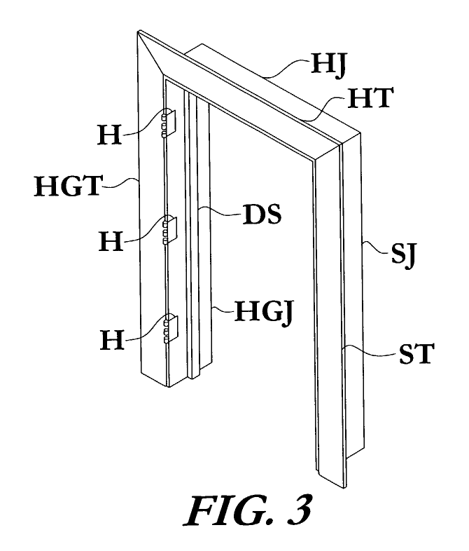

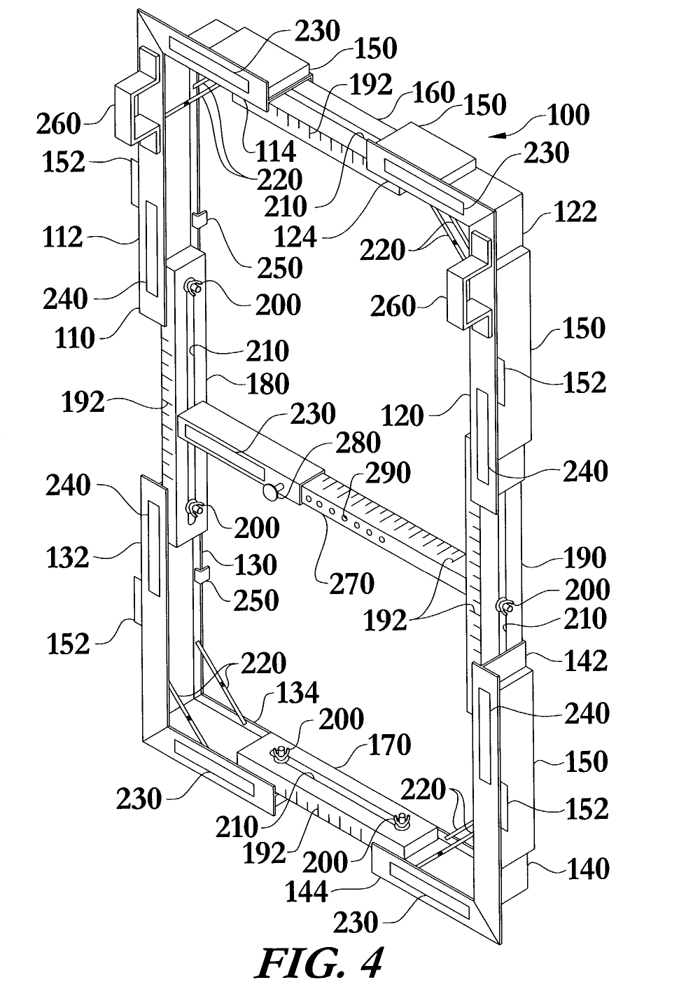

With reference now to the accompanying figures and specifically to FIG. 4, in one of the many preferable configurations, the apparatus 100 for installing a frame, generally consisting of a head jamb HJ, strike jamb SJ, and a hinge jamb HGJ, and related appurtenances, generally including hinges H, a strike plate SP, door stop DS pieces and trim HT, HGT, and ST, as shown in FIG. 1, FIG. 2, FIG. 3 and FIG. 4, incorporates, among other elements, four corner members 110, 120, 130, 140 slidably and releasably joined together with height adjusters 180, 190 and width adjusters 160, 170. Referring again to FIG. 4, the four corner members include a head-hinge frame member 110, a head-strike frame member 120, a base-hinge frame member 130, and a base-strike frame member 140. Each member is formed with a trim piece mounting ledge 310.

Each corner member includes two sections that are substantially orthogonal to one another while in use. The sections may be substantially parallel to each other when in the folded position. While in use, at least one hinged stabilization member 220 may be used to join the two sections ensuring their substantially orthogonal relationship and providing additional stability and rigidity to the apparatus 100. The two sections of the head-hinge frame member 110 include an upper hinge frame section 112 and a hinge side head frame section 114. Similarly, the head-strike frame member 120 includes an upper strike frame section 122 and a strike side head frame section 124. Additionally, the base-hinge frame member 130 includes a lower hinge frame section 132 and a hinge side base frame section 134. Lastly, the base-strike frame member 140 includes a lower strike frame section 142 and a strike side base frame section 144.

The head-hinge frame member 110 and the head-strike frame member 120 are adjustably and releasably joined together with a horizontal head width adjuster 160 having a hinge end and a strike end. The hinge end slidably and releasably mates with the hinge side head frame section 114 of the head-hinge frame member 110. The strike end slidably and releasably mates with the strike side head frame section 124 of the head-strike frame member 120.

The base-hinge frame member 130 and the base-strike frame member 140 are adjustably and releasably joined together with a horizontal base width adjuster 170 having a hinge end and a strike end. The hinge end slidably and releasably mates with the hinge side base frame section 134 of the base-hinge frame member 130. The strike end slidably and releasably mates with the strike side base frame section 144 of the base-strike frame member 140.

The head-hinge frame member 110 and the base-hinge frame member 130 are adjustably and releasably joined together with a vertical hinge height adjuster 180 having a lower end and an upper end. The lower end slidably and releasably mates with the lower hinge frame section 132 of the base-hinge frame member 130. The upper end slidably and releasably mates with the upper hinge frame section 112 of the head-hinge frame member 110.

The head-strike frame member 120 and the base-strike frame member 140 are adjustably and releasably joined together with a vertical strike height adjuster 190 having a lower end and an upper end. The lower end slidably and releasably mates with the lower strike frame section 142 of the base-strike frame member 140. The upper end slidably and releasably mates with the upper strike frame section 122 of the head-strike frame member 120.

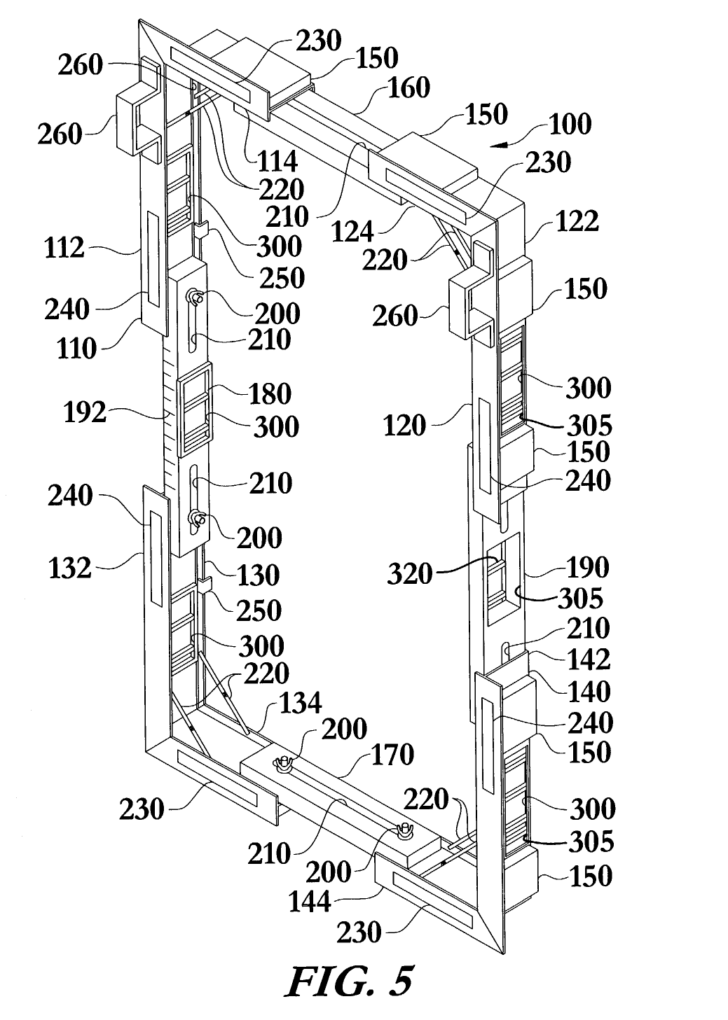

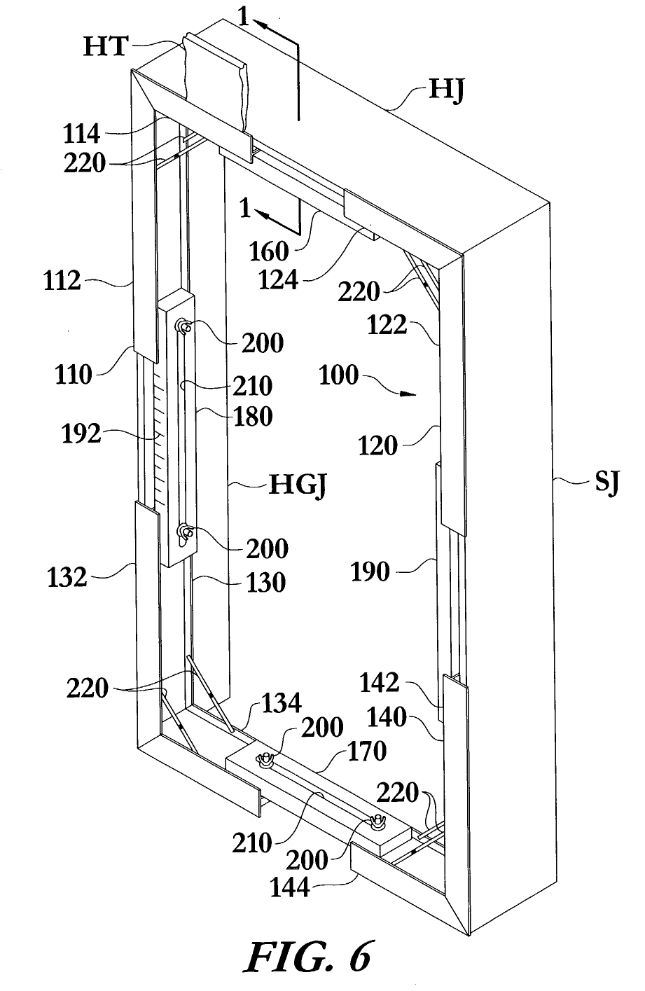

Numerous embodiments incorporate variations of the width adjusters 160, 170 and the height adjusters 180, 190. The embodiment illustrated in FIG. 4, FIG. 5, and FIG. 6 incorporates an engagement device slot 210 formed in the adjuster 160, 170, 180, 190. The slot 210 slidably and releasably receives a releasable adjuster engagement device 200. The releasable adjuster engagement device 200 may be as simple as a threaded stud affixed to the corner frame members 110, 120, 130, 140 upon which a wing-nut type device is threaded and tightened against the adjuster 160, 170, 180, 190. Numerous other releasable adjuster engagement devices 200 may be incorporated into the apparatus 100. For example, any number of quick release type engagement devices may be incorporated in the apparatus 100. A further variation of an alternative releasable adjuster engagement device 200 is illustrated in FIG. 4 on the intermediate adjustable brace 270 wherein the brace engagement device 280 is a stud type engager that may be spring loaded and releasably engages into an engagement recess 290 formed in the intermediate adjustable brace 270.

Additional variations of the width adjusters 160, 170 and the height adjusters 180, 190 may include telescoping variations. For instance, the adjusters 160, 170, 180, 190 may be formed as hollow receivers to releasably and slidably receive the corner frame members 110, 120, 130, 140. Alternatively, the corner frame members 110, 120, 130, 140 may be formed as hollow receivers to releasably and slidably receive the adjusters 160, 170, 180, 190.

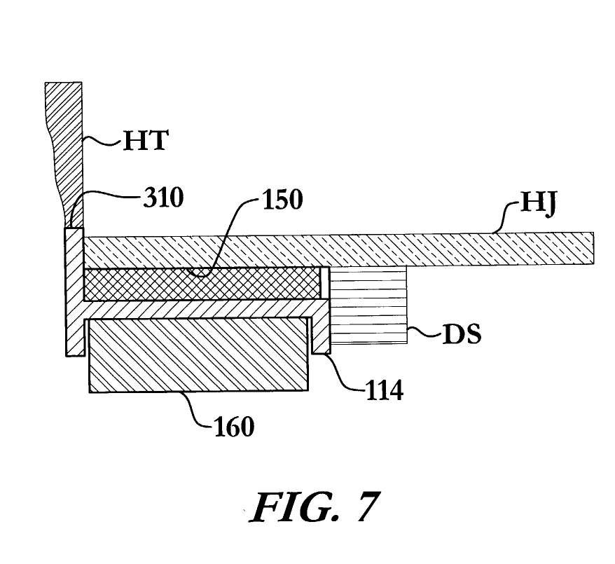

As noted above, each of the apparatus corner frame members 110, 120, 130, 140 is formed with a trim piece mounting ledge 310, as illustrated in FIG. 7. The trim piece mounting ledge 310 provides a surface against which a user can abut a frame trim section to assure a uniform reveal, the amount of jamb material exposed to view once the frame trim section is installed. The apparatus frame members 110, 120, 130, 140 may be formed with a unique thickness, or may include trim setback members 150, to accommodate varying jamb material thickness and the desired reveal.

Referring again to FIG. 4, the apparatus 100 may additionally include a number of trim setback extension members 152 to vary the reveal. For instance, one embodiment may be set-up for a standard one-quarter inch reveal may be modified to provide any number of alternative reveals through the use of trim setback extension members 152. Such trim setback extension members 152 may be releasably and slidably attached to the apparatus frame members 110, 120, 130, 140. Further, they may be hingedly attached to the apparatus frame members 110, 120, 130, 140 to swing into position when desired and retract when the apparatus' standard reveal is desired.

In additional embodiments, any of the adjusters 160, 170, 180, 190 or the intermediate adjustable brace 270 described above may include measurement indicia 192. Such indicia 192 may aide in assuring orthogonal nature of all corners of the apparatus 100. Additionally the apparatus may include a plurality of level 230 and plumb 240 indicating devices attached to the apparatus 100. The level 230 and plumb 240 indicating devices may be of the traditional bubble and liquid type or more advanced electronic indicators.

Generally the corner members' 110, 120, 130, 140 depth will be such to locate the desired position of one of the many potential appurtenances attached to a frame during the framing process. For example, when the apparatus 100 is utilized in the framing of doors the corner members' 110, 120, 130, 140 depth may be approximately equal to standard depth of a door. As illustrated in FIG. 6 and FIG. 7, this would allow the user to abut the pieces of a door stop DS against the apparatus corner members 110, 120, 130, 140 thereby ensuring the correct location of the stop DS on the jamb HJ, SJ, HGJ. Further, a plurality of stop locator extension devices 250 may be releasably and slidably secured to the apparatus frame members 110, 120, 130, 140. Such stop locator extension devices 250 may be convenient when using an apparatus 100 of a specific depth to locate the door stop DS of a door having a depth greater than that of the apparatus 100. Additionally, the stop locator extension devices 250 may be hingedly attached to the apparatus frame members 110, 120, 130, 140 to swing into position when desired and retract when unnecessary.

Additional embodiments may include an intermediate adjustable brace 270 that may be adjustably and releasably attached to the apparatus 100. The intermediate adjustable brace 270 may add strength and rigidity to the apparatus 100 while also preventing bowing of the apparatus 100. Such an intermediate brace 270 may be particularly useful in framing large openings such as those required for sliding glass doors. Additionally, the intermediate adjustment brace 270 may be hingedly attached to the apparatus 100. Further, the intermediate brace 270 may include measurement indicia 192. Such indicia 192 may aide in assuring orthogonal nature of all corners of the apparatus 100.

Referring now to FIG. 5, an additional embodiment directed toward the installation of door frames may include at least one hinge template 300 adjustably attached to the apparatus 100. The hinge template 300 may be designed for use with a router, hand tools, or simply to outline a hinge size and location. The hinge template 300 may be adjustably attached to the apparatus 100 so that the entire template 300 may be moved on the apparatus 100. This may be accomplished through the use of a template adjustment recess 305 formed in the apparatus frame members 110, 120, 130, 140 or the adjusters 160, 170, 180, 190. Additionaly, the hinge template 300 itself may be adjustable to accommodate the mortising of standard 3″, 3-½″ and 4″ hinges H as well as any custom hinge size and any door thickness. An additional variation includes a door strike template 320 adjustably attached to the apparatus 100. The door strike template 320 may include both a template for the strike plate 320 and a template for the lock bolt.

Any of the preceding embodiments may include a plurality of gripping devices 260 attached to the apparatus 100 for ease in handling.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations for compatibility with the plurality of assembly activities that require the assembly of a frame, including for purposes of illustration, and not limitation, cabinet making, furniture making, window framing and installation, and door framing and installation. Accordingly, even though only few variations of the present invention are described herein, it is to be understood that the practice of such additional modifications and variations and the equivalents thereof, are within the spirit and scope of the invention as defined in the following claims.

The corresponding structures, materials, acts, and equivalents of all means or step plus function elements in the claims below are intended to include any structure, material, or acts for performing the functions in combination with other claimed elements as specifically claimed.

I claim:

1. An apparatus for installing a frame and related appurtenances, including a plurality of trim pieces, and a plurality of stop pieces, comprising:
a head-hinge frame member, formed with a trim piece mounting ledge, having an upper hinge frame section and a hinge side head frame section;
a head-strike frame member, formed with a trim piece mounting ledge, having an upper strike frame section and a strike side head frame section;
a base-hinge frame member, formed with a trim piece mounting ledge, having a lower hinge frame section and a hinge side base frame section;
a base-strike frame member, formed with a trim piece mounting ledge, having a lower strike frame section and a strike side base frame section;
a horizontal head width adjuster, having a hinge end and a strike end, slidably and releasably mated at the hinge end to the hinge side head frame section and slidably and releasably mated at the strike end to the strike side head frame section;
a horizontal base width adjuster, having a hinge end and a strike end, slidably and releasably mated at the hinge end to the hinge side base frame section and slidably and releasably mated at the strike end to the strike side base frame section;
a vertical hinge height adjuster, having a upper end and a lower end, slidably and releasably mated at the upper end to the upper hinge frame section and slidably and releasably mated at the lower end to the lower hinge frame section; and
a vertical strike height adjuster, having a upper end and a lower end, slidably and releasably mated at the upper end to the upper strike frame section and slidably and releasably mated at the lower end to the lower strike frame section.

2. The apparatus according to claim 1, further including a plurality of trim setback members attached to the apparatus.

3. The apparatus according to claim 1, further including (a) at least one trim setback extension member releasably and slidably attached to the upper hinge frame section, (b) at least one trim setback extension member releasably and slidably attached to the hinge side head frame section, (c) at least one trim setback extension member releasably and slidably attached to the upper strike frame section, (d) at least one trim setback extension member releasably and slidably attached to the strike side head frame section, (e) at least one trim setback extension member releasably and slidably attached to the lower hinge frame section, and (f) at least one trim setback extension member releasably and slidably attached to the lower strike frame section.

4. The apparatus according to claim 1, further including measurement indicia on the horizontal head width adjuster, the horizontal base width adjuster, the vertical hinge height adjuster, and the vertical strike height adjuster.

5. The apparatus according to claim 1, further including a plurality of level indicating devices and plumb indicating devices attached to the apparatus.

6. The apparatus according to claim 1, further including a plurality of stop locator extension devices releasably and slidably attached to the apparatus.

7. The apparatus according to claim 1, further including a plurality of gripping devices attached to the apparatus.

8. The apparatus according to claim 1, further including an intermediate adjustable brace having a proximal end and a distal end adjustably and releasably attached to the apparatus.

9. The apparatus according to claim 1, further including at least one hinge template adjustably attached to the apparatus.

10. The apparatus according to claim 1, further including a door strike template adjustably attached to the apparatus.

11. An apparatus for installing a door frame and related appurtenances, including a plurality of trim pieces, and a plurality of stop pieces, at locations relative to each other thus defining the amount of frame material exposed to view when installed, known as a reveal, comprising:
a head-hinge frame member having a width approximately equal to a 1-⅜″ deep standard door, formed with a trim piece mounting ledge, and having an upper hinge frame section and a hinge side head frame section;
a head-strike frame member having a width approximately equal to a 1-⅜″ deep standard door, formed with a trim piece mounting ledge, and having an upper strike frame section and a strike side head frame section;
a base-hinge frame member having a width approximately equal to a 1-⅜″ deep standard door, formed with a trim piece mounting ledge, and having a lower hinge frame section and a hinge side base frame section;
a base-strike frame member having a width approximately equal to a 1-⅜″ deep standard door, formed with a trim piece mounting ledge, and having a lower strike frame section and a strike side base frame section;
a horizontal head width adjuster, having a hinge end and a strike end, slidably and releasably mated at the hinge end to the hinge side head frame section and slidably and releasably mated at the strike end to the strike side head frame section;
a horizontal base width adjuster, having a hinge end and a strike end, slidably and releasably mated at the hinge end to the hinge side base frame section and slidably and releasably mated at the strike end to the strike side base frame section;
a vertical hinge height adjuster, having a upper end and a lower end, slidably and releasably mated at the upper end to the upper hinge frame section and slidably and releasably mated at the lower end to the lower hinge frame section;
a vertical strike height adjuster, having a upper end and a lower end, slidably and releasably mated at the upper end to the upper strike frame section and slidably and releasably mated at the lower end to the lower strike frame section;
a plurality of level indicating devices attached to the apparatus; and
a plurality of plumb indicating devices attached to the apparatus.

12. The apparatus according to claim 11, further including a plurality of trim setback members having a depth that establishes the reveal at approximately one-quarter inch.

13. The apparatus according to claim 11, further including (a) at least one trim setback extension member releasably and slidably attached to the upper hinge frame section used to vary the reveal, (b) at least one trim setback extension member releasably and slidably attached to the hinge side head frame section used to vary the reveal, (c) at least one trim setback extension member releasably and slidably attached to the upper strike frame section used to vary the reveal, (d) at least one trim setback extension member releasably and slidably attached to the strike side head frame section used to vary the reveal, (e) at least one trim setback extension member releasably and slidably attached to the lower hinge frame section used to vary the reveal, and (f) at least one trim setback extension member releasably and slidably attached to the lower strike frame section used to vary the reveal.

14. The apparatus according to claim 11, further including measurement indicia on the horizontal head width adjuster, the horizontal base width adjuster, the vertical hinge height adjuster, and the vertical strike height adjuster.

15. The apparatus according to claim 11, further including a plurality of stop locator extension devices releasably and slidably attached to the apparatus.

16. The apparatus according to claim 11, further including a plurality of gripping devices attached to the apparatus.

17. The apparatus according to claim 11, further including an intermediate adjustable brace having a proximal end and a distal end adjustably and releasably attached to the apparatus.

18. The apparatus according to claim 11, further including at least one hinge template and at least one door strike template adjustably attached to the apparatus.

19. A means for installing a frame, including a hinge jamb, strike jamb, head jamb, and potentially a base jamb, and related appurtenances, including a plurality of trim pieces, and a plurality of stop pieces, comprising:
a head-hinge means for substantially orthogonally orienting and maintaining the head jamb and the hinge jamb during installation, which is formed with a reveal adjusting means;
a head-strike means for substantially orthogonally orienting and maintaining the head jamb and the strike jamb during installation, which is formed with a reveal adjusting means;
a base-hinge means for substantially orthogonally orienting and maintaining the base jamb and the hinge jamb during installation, which is formed with a reveal adjusting means;
a base-strike means for substantially orthogonally orienting and maintaining the base jamb and the strike jamb during installation, which is formed with a reveal adjusting means;
a horizontal head width adjustment means for adjusting the horizontal separation distance between the head-hinge means and the head-strike means;
a horizontal base width adjustment means for adjusting the horizontal separation distance between the base-hinge means and the base-strike means;
a vertical hinge height adjustment means for adjusting the vertical separation distance between the head-hinge means and the base-hinge means;
a vertical strike height adjustment means for adjusting the vertical separation distance between the head-strike means and the base-strike means;

20. The means for installing a frame and related appurtenances according to claim 19, further including a level establishing means attached to the frame and appurtenances installing means and a plumb establishing means attached to the frame and appurtenances installing means.
